(19) United States
(12) Patent Application Publication
(10) Pub. No.: US 2016/0291340 A1
(43) Pub. Date: Oct. 6, 2016

(54) Optical eyewear with reduced reflectivity for scattered light

(71) Applicant: RealD Inc., Beverly Hills, CA (US)

(72) Inventor: Gary Sharp, Boulder, CO (US)

(21) Appl. No.: 15/085,878

(22) Filed: Mar. 30, 2016

Related U.S. Application Data
(60) Provisional application No. 62/140,446, filed on Mar. 30, 2015.

(51) Int. Cl. G02B 27/26; G02B 1/11; G02B 5/30; G02B 27/28; G02B 27/22; G02B 5/28

(52) U.S. Cl. CPC G02B 27/26; G02B 27/2207; G02B 5/28; G02B 5/3083; G02B 27/288; G02B 1/11

(57) ABSTRACT

Disclosed herein are eyewear and system for encoding and decoding images with spectral division or hybrid spectral division/polarization. The disclosed eyewear may include interference filters and circular polarizer optically following the interference filters to reduce the reflection of scatter light from the viewer.

### RELATED APPLICATIONS

This is a non-provisional application claiming priority to U.S. Provisional Patent Application No. 62/140,446 filed Mar. 30, 3015 entitled “Optical Eyewear with Reduced Reflectivity for Scattered Light,” incorporated herein in its entirety.

### TECHNICAL FIELD

This disclosure generally relates to optical eyewear and, more particularly, relates to eyewear operable to encode or decode an image using spectral division.

### BACKGROUND

Spectral division may involve projecting a pair of images with distinct RGB spectra, which are analyzed by filters transmitting the appropriate set. This approach has both two-dimensional (2-D) and three-dimensional (3-D) applications. In 2-D applications, different viewers may use eyewear having the corresponding filters to receive only image encoded by the corresponding RGB spectra. 2-D applications using spectral division may include, for example, gaming, privacy viewing, or multiplexed viewing. In 3-D applications, left and right-eye images may be encoded by substantially non-overlapping RGB spectra and decoded by corresponding filters for the left and right eyes.

### SUMMARY

An exemplary embodiment of optical eyewear of the present disclosure may include an interference filter having a passband spectrum at a normal angle, a quarter wave retarder optically following the interference filter, and a linear polarizer optically following the quarter wave retarder. The linear polarizer may be operable to allow a first portion of scattered light having a first linear polarization to pass through the quarter wave retarder towards the interference filter and absorb a second portion of the scattered light having a polarization state other than the first linear polarization. The interference filter may be operable to reflect a reflected portion of the first portion of the scattered light back through the quarter wave retarder towards the linear polarizer, whereby the reflected portion of the first portion of the scattered light passes through the quarter wave retarder in a double pass, and the polarization state of the reflected portion of the first portion of the scattered light is converted from the first linear polarization to a second linear polarization substantially orthogonal to the first linear polarization. The reflected portion of the first portion of the scattered light is substantially absorbed by the linear polarizer.

### BRIEF DESCRIPTION OF THE DRAWINGS

FIG. 1 is a schematic diagram of a conventional interference filter;

FIG. 2 is a schematic diagram of an embodiment of optical eyewear in accordance with the present disclosure;

FIG. 3 is a schematic diagram of another embodiment of optical eyewear in accordance with the present disclosure; and

FIG. 4 is a schematic diagram of yet another embodiment of optical eyewear in accordance with the present disclosure.

### DETAILED DESCRIPTION

The present application includes various embodiments for eyewear operable to decode images encoded with substantially non-overlapping spectra. It is to be appreciated that while certain embodiments may be discussed with respect to a 2-D or 3-D embodiment, the principles of the present disclosure are applicable to both 2-D and 3-D embodiments.

In a 3-D embodiment, spectral division allows matte-white screens, provided that sufficient luminance is achieved at low gain. In laser-based spectral division 3-D, the source can be considered “pre-filtered”, requiring no filtering at the projector. This gives a large boost in 3-D-efficiency relative to lamp-based systems. If any encoding-hardware is use, it may be disposed in the illumination path, with no contrast/dynamic-range penalty.

Based on the above, concerns about 3-D dynamic range rest in the limitations of the eyewear filters. Conventional spectral division eyewear filters do not address all the requirements of a spectral division eyewear lens. To allow for acceptable performance, engineered filter spectra would have high pass-band efficiency, high stop-band rejection (without contributing stray light), steep transition slopes, and angle insensitivity. Low cost/area, durable, and lightweight are also design considerations.

Dyes used for traditional anaglyph are attractive in many ways, but lack the spectral selectivity required to implement spectral division 3-D.

An interference filter comprises a plurality of layers and relies upon reflection as a means of rejecting the unwanted portion of the spectrum. Functionally, an interference filter is a highly reflective mirror for all wavelengths in the stop-band. However, interference filter transmission/reflection spectra are not stable, due to angle-dependence of optical path-length. Such an angular dependence may be a characteristic of all spectral filters made of layered structure.¹ The challenge is therefore to meet the 3-D decoding performance over the lens field-of-view (FOV). ¹See Pochi Yeh, Optical Waves in Layered Media, §7.6, 161-63 (1988), which is hereby incorporated by reference in its entirety.

Lasers represent a best-case scenario in that the power spectra are extremely concentrated. But for any reasonable separation of primaries, there remains a challenge to maintaining pass-band efficiency (determining brightness/color uniformity), and stop-band rejection (determining stereo-contrast-ratio or “SCR”), over the entire FOV. In an embodiment, the impact of spectral-shift can be mitigated by curving the lens, and limiting the FOV by using smaller lenses. Glass lenses are fabricated by depositing the multilayer stack on a compound-curved surface. Web-fabricated lenses appear limited to cylindrical curvature (i.e. not thermo-formable).

In general, image light is scattered from the viewer and reflected by an eyewear lens. This forms an image of the viewer at approximately the relief distance in front of the lens, which is superimposed on the transmitted image. In addition to impacting dynamic range, significant eyewear lens-reflection is a catalyst for eye-strain when present over extended usage periods; a situation likely exacerbated when attempting to fuse stereoscopic images. This is compounded when using Rx lenses (i.e. due to increased relief distance, and additional surfaces).

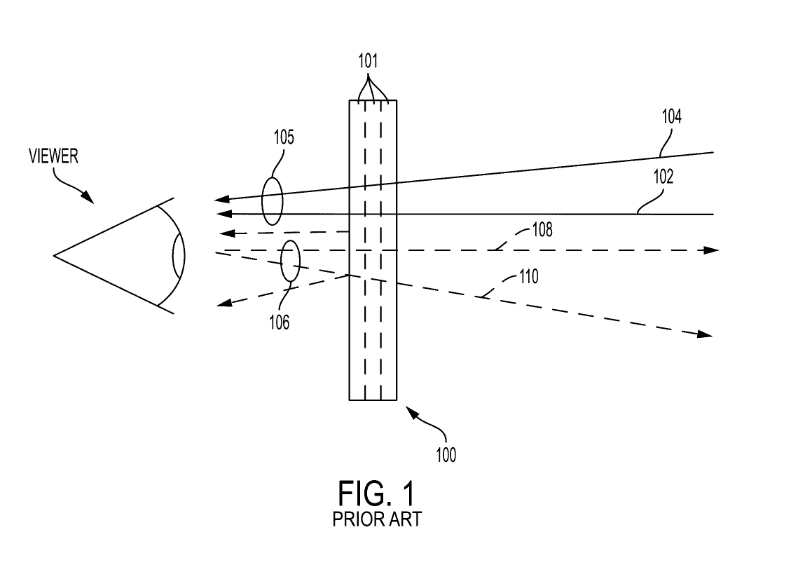

FIG. 1 is a schematic diagram showing a conventional interference filter 100 having a plurality of layers 101, thereby resulting in a pass-band spectrum for light incident at a normal angle. The transmission of the desired set of primary color bands is designed to be a maximum at normal incidence, and the transmission of the (rejected) primary color bands intended for the other eye is as close to zero as possible. As such, light encoded with the pass-band spectrum may be incident on the interference filter 100 along light path 102 at a normal angle and would be allowed to pass through the interference filter 100. Light encoded with the stop-band spectrum may be incident on the filter 100 at a normal angle along light path 102 and would be reflected by the interference filter 100.

The pass-band spectrum of the interference filter 100 may have a characteristic blue shift at an angle off-normal. Due to the blue-shift, the transmission of the desired set of primary color bands in light along light path 104 tends to decay with a large incidence angle, while the transmission of the rejected set of primary color bands increases. As such, the light 105 incident on the viewer through the interference filter 100 contains a mixture of the two sets of spectra.

A portion of the scattered light 106 along the off-normal path 110 may be reflected from the interference filter 100 due to the desired set of primary color bands being rejected by the shifted pass-band at off-normal angle. A portion of the scattered light 106 along the normal path 108 may be reflected from the interference filter 100 due the scattered light containing some rejected set of primary color band. While the illuminance of the viewer associated with the rejected set of primaries is relatively weak, the reflectivity of the interference filter 100 near normal incidence is relatively high. As such, both sets can contribute substantially to the overall ghost level.

An estimate for the impact of spectral division 3-D eyewear on dynamic range can be provided by a simple model using measurements of the laser power spectra and the dichroic-filter spectra. A white field is projected onto a matte-white cinema screen, which appears completely uniform. For 3-D, there are two such images superimposed, each composed of a unique set of primaries, but with substantially the same (photopic) brightness, L₀.

A viewer is bathed in light emanating from the solid-angle subtended by the screen, with secondary scattering sources neglected. A portion of light incident on the eyewear lens is transmitted to the viewer eye/face. The lens transmission spectrum, T(Δ,θ), is a function of wavelength and angle with respect to the lens normal, but is assumed azimuth-independent. The lens receives light with the power spectrum for the intended 3D view perspective (the pass-band), S_{P}(λ), and light with the power spectrum intended for the other eye (the stop-band), S_{S}(λ). Photopic transmission efficiency functions are given by:

$${η}_{P , S} ( θ ) = \frac{\int {S}_{P , S} ( λ ) T ( λ , θ ) \overline{y} ( λ ) d λ}{\int {S}_{P , S} ( λ ) \overline{y} ( λ ) d λ}$$

where γ̅(λ) is the photopic response curve. Note that the ratio of these terms (η_{P}(θ)/η_{S}(θ)) gives the angle dependent SCR.

The illuminance (lumens/m²) at the eye is obtained by summing differential screen contributions transmitted through the lens. For simplicity, it is assumed that the image includes a uniform white circular patch, subtending a half-angle, θ_{S}, with the viewer position/gaze at screen-center. The illuminance from each spectrum is given by

E_{P,S}=2πL₀I_{P,S}

where,

I_{P,S}=∫₀^{θ}^{_{S}}(θ)sin θ cos θdθ

The viewer may be considered a diffuse scatterer (e.g. disregard the specular lobe), with photopic reflectance (albedo), ρ. For a lambertian scatterer, the observed brightness of the viewer is linearly proportional to the illuminance, or L=ρE/π.

The observed brightness of the viewer is given by summing the contributions from the two power spectra, which are L_{P,S}=2 μL₀I_{P,S}.

The lens acts as a partial reflector. It forms a virtual image of the viewer, with brightness proportional to lens reflectance. Lens curvature slightly modifies the image location/magnification.

The Viewer Ghost Contrast (VGC) is defined here as the ratio of the normal-incidence brightness of the transmitted light, to the brightness of the viewer ghost reflected by the lens. The brightness of the transmitted light is given by

L=L₀η_{P}(0)

where it is assumed that the lens completely extinguishes the stop-band at normal incidence (η_{S}(0)=0).

As before, photopic reflection efficiencies may be calculated for each power spectrum with knowledge of the lens reflectivity spectrum, R(λ,θ),

$${κ}_{P , S} ( θ ) = \frac{\int {S}_{P , S} ( λ ) R ( λ , θ ) \overline{y} ( λ ) d λ}{\int {S}_{P , S} ( λ ) \overline{y} ( λ ) d λ}$$

The viewer-ghost-contrast is therefore given by

$$V G C = \frac{{η}_{ρ} ( 0 )}{2 ρ [ {κ}_{P} ( 0 ) {I}_{P} + {κ}_{S} ( 0 ) {I}_{S} ]}$$

It is to be appreciated that while the viewer illuminance from the pass-band is much higher than that of the stop-band, the reflection-efficiency of the latter is much higher, so both terms can be significant.

The model for a spectral division stereoscopic laser system based on the above predicts a disparity between left and right-eye SCR/VGC levels, attributed to the blue-shift of the eyewear transmission spectrum as a function of incidence angle. At approximately 15° incidence angle, there is an abrupt increase in the right-eye stop-band transmission. This occurs for the long-wavelength primary set because the interference filter transmission spectrum encroaches on the short-wavelength set.

Another of characteristic of VGC is sensitivity to screen proximity. Viewers close to the screen have higher illuminance, which reduces VGC. Additionally, interference filters perform worse at larger incidence angles, reducing both SCR and VGC over the FOV. However, a spectral division 3-D system preserves the high SCR zone with head movement, because it only depends upon the input spectra.

A spectral-division, or hybrid spectral-division/polarization based system of the present disclosure may be used to obtain high viewer ghost contrast (VGC) ratio. One way to reduce the brightness of the viewer ghost is to simply reduce the reflectivity of the lens through design. However, designing and consistently building an interference filter with over 1,000:1 contrast (ratio of screen brightness to ghost brightness) can be very challenging, when angle and wavelength sensitivity are taken into consideration. Instead, an embodiment of the spectral-division, or hybrid spectral-division/polarization based systems of the present disclosure may include a circular polarizer in the interior of the eyewear lens. The circular polarizer may include a linear polarizer and a 45-degree oriented quarter-wave retarder. Light scattered from the viewer may pass through a linear polarizer, and then through a 45-degree oriented quarter-wave retarder. Any down-stream reflections, including those from non-zero reflectivity dichroic coatings, are absorbed because a double-pass of the quarter-wave retarder converts the polarization of scattered light to the orthogonal polarization, and it is then absorbed by the polarizer in the return-pass. Further reflectivity reduction can be achieved by including an anti-reflection (AR) coating on the interior of the lens.

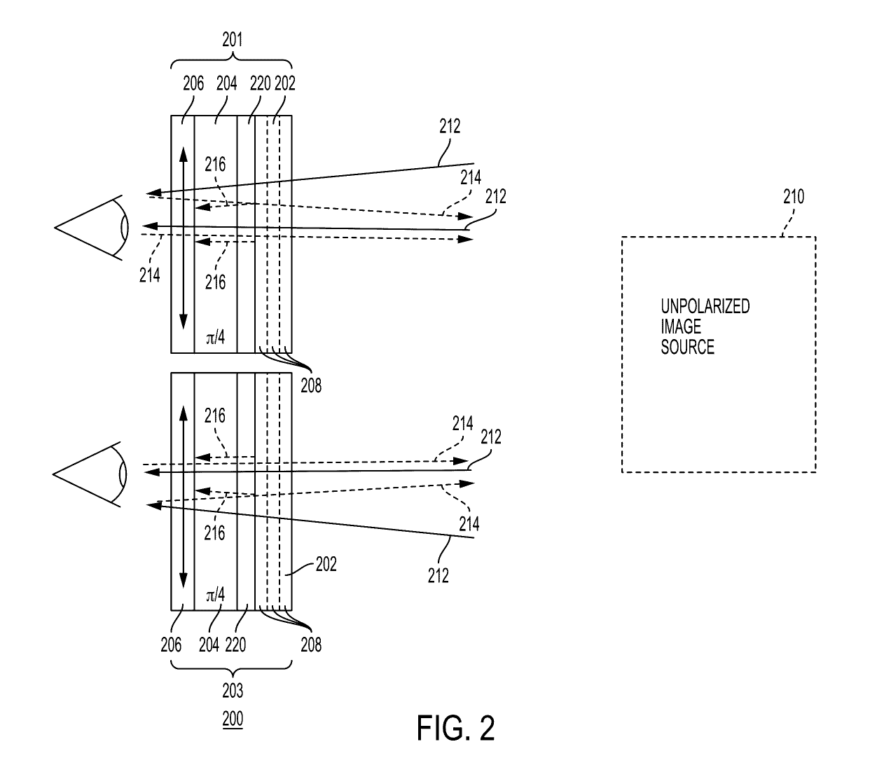

FIG. 2 is a schematic diagram illustrating an exemplary optical eyewear 200 of the present disclosure. The optical eyewear 200 may include optical eyewear filters 201, 203 which may each include an interference filter 202. In an embodiment, the interference filter 202 of the optical eyewear filters 201, 203 may each have a plurality of layers 208 and substantially non-overlapping pass-band spectra at a normal incident angle, thereby allowing the interference filters 202 to decode stereoscopic left and right-eye images encoded with different sets of primary color bands. For example, the passbands of the filters 201, 203 may include complementary colors or substantially non-overlapping primary colors, such as R1G1B1 and R2G2B2, respectively. In another embodiment, the interference filter 202 of the optical eyewear filters 201, 203 may have substantially the same passband spectra at a normal incident angle. Such a configuration would allow the viewer to receive 2-D images intended only for the viewer.

To reduce the reflectivity of eyewear 200 for the scattered light from the viewer, the optical eyewear filters 201, 203 may each include a quarter wave retarder 204 optically following the interference filter 202, and a linear polarizer 206 optically following the quarter wave retarder 204. The quarter wave retarder 204 may be oriented with respect to the linear polarizers 206 at 45 degrees.

In operation, unpolarized light from an unpolarized image source 210 with mixed pass-band spectra may pass through the interference filters 202 along light paths 212 at normal and off-normal angles. The image source 210 may be any source that provides image light towards the eyewear 200, including, for example, a direct view display or a projection system including a matte white projection screen.

The unpolarized incident light that passed through the interference filters 202 would pass through the quarter wave retarders 204 without being polarized until only a portion of the incident light is allow to pass through the linear polarizers 206 and reach the viewer.

The light reaching the viewer would be scattered and depolarized by the viewer. The scattered light 214 would be directed back towards the eyewear 200. The linear polarizers 206 are further operable to allow a first portion of scattered light 214 having a first linear polarization to pass through the quarter wave retarders 204 towards the interference filters 202 and absorb a second portion of the scattered light 214 having a polarization state other than the first linear polarization. As such, substantially no scattered light 214 is reflected towards the viewer to contribute to a ghost image.

Furthermore, some of the first portion of the scatter light 214 that passes through the linear polarizers 206 and quarter wave retarders 204 are allowed to pass through the interference filters 202 towards ambient space. The linear polarizers 206 are operable to reflect only a reflected portion 216 of the first portion of the scattered light 214 back through the quarter wave retarders 204 towards the linear polarizers 206. However, the reflected portion 216 of the first portion of the scattered light 214 would pass through the quarter wave retarders 204 in a double pass, and the polarization state of the reflected portion 216 of the first portion of the scattered light 214 would be converted from the first linear polarization to a second linear polarization substantially orthogonal to the first linear polarization. As such, the reflected portion 216 of the first portion of the scattered light 214 may be substantially absorbed by the linear polarizers 206 and would not be able to contribute to a ghost image.

In an embodiment, the optical eyewear filters 201, 203 may include an optional anti-reflective coating layer 220 in between the interference filter 202 and linear polarizer 206 to further reduce reflectivity of the scattered light 214. It is to be appreciated that while the location of the anti-reflective layer 220 is shown in FIG. 2 to be located between the interference filter 202 and the quarter wave retarder 204, but the anti-reflective layer 220 could also be located between the linear polarizer 206 and the quarter wave retarder 204.

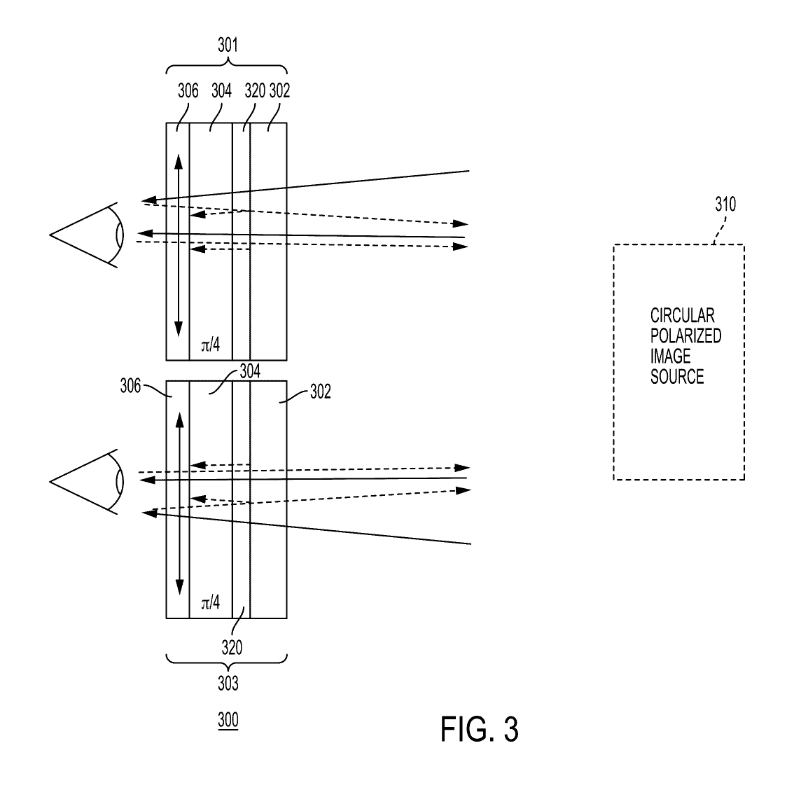

FIG. 3 is a schematic diagram illustrating an exemplary optical eyewear 300 of the present disclosure. The eyewear 300 is similar to eyewear 200 shown in FIG. 2, except the eyewear 300 is configured to receive incident light from a circular polarized image source 310. The image source 310 may be any source that provides circularly polarized image light towards the eyewear 300, including, for example, a direct view display or a projection system including a polarization preserving projection screen.

The optical eyewear 300 may include optical eyewear filters 301, 303 which may each include an interference filter 302, a quarter wave retarder 304 optically following the interference filter 302, and a linear polarizer 306 optically following the quarter wave retarder 304. The quarter wave retarders 304 may be oriented with respect to the linear polarizers 306 at 45 degrees. Furthermore, a slow axis of the quarter wave retarders 304 may be orthogonally oriented with respect to the slow axis of the circularly polarized image light from the image source 310 to result in substantially zero net retardation. In such a configuration, polarization is not used to encode the stereoscopic imagery; that is accomplished using spectral division. Rather, a polarization scheme allows for the rejection of the viewer ghost, achieving high VGC ratio.

In an embodiment, the optical eyewear filters 301, 303 may include an optional anti-reflective coating layer 320 in between the interference filter 302 and linear polarizer 306 to further reduce reflectivity of the scattered light. It is to be appreciated that while the location of the anti-reflective layer 320 is shown in FIG. 3 to be located between the interference filter 302 and the quarter wave retarder 304, but the anti-reflective layer 320 could also be located between the linear polarizer 306 and the quarter wave retarder 304.

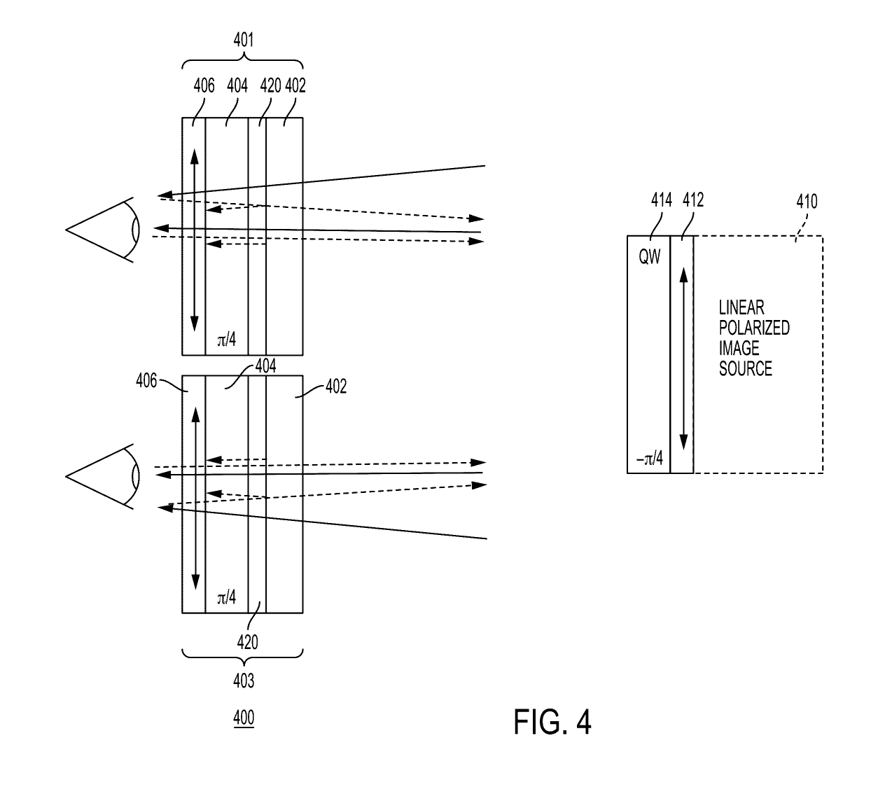

FIG. 4 is a schematic diagram illustrating an exemplary optical eyewear 400 of the present disclosure. The eyewear 400 is similar to eyewear 200 and 300 shown in FIGS. 2 and 3, except the eye wear 400 is configured to receive incident light from a linearly polarized image source 410. The image source 410 may be any source that provides linearly polarized image light towards the eyewear 400, including, for example, a direct view display or a projection system including a polarization preserving projection screen.

The optical eyewear 400 may include optical eyewear filters 401, 403 which may each include an interference filter 402, a quarter wave retarder 404 optically following the interference filter 402, and a linear polarizer 406 optically following the quarter wave retarder 404. The quarter wave retarders 404 may be oriented with respect to the linear polarizers 406 at 45 degrees. Furthermore, an image source polarizer 412 may optically follow the linear polarized image source 410 and have an optical axis in general alignment with the linear polarizers 406. An image source quarter wave retarder 414 may further optically follow the polarizer 412 and has a slow axis that is crossed with the slow axis of the quarter wave retarders 404 result in substantially zero net retardation. Again, in such a configuration, polarization is not used to encode the stereoscopic imagery; that is accomplished using spectral division. Rather, a polarization scheme allows for the rejection of the viewer ghost, achieving high VGC ratio.

It is to be appreciated that the image sources 210, 310, and 410 may be any stereoscopic or non-stereoscopic systems that output at least two different images encoded by spectral division. Such systems may output images without polarization (e.g., image source 210) or with polarization (310 and 410).

In an embodiment, the optical eyewear filters 401, 403 may include an optional anti-reflective coating layer 420 in between the interference filter 402 and linear polarizer 406 to further reduce reflectivity of the scattered light. It is to be appreciated that while the location of the anti-reflective layer 420 is shown in FIG. 4 to be located between the interference filter 402 and the quarter wave retarder 404, but the anti-reflective layer 420 could also be located between the linear polarizer 406 and the quarter wave retarder 404.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. An optical eyewear filter comprising:
an interference filter having a passband spectrum;
a quarter wave retarder optically following the interference filter; and
a linear polarizer optically following the quarter wave retarder;
wherein the linear polarizer is configured to allow a first portion of scattered light having a first linear polarization to pass through the quarter wave retarder in a first pass towards the interference filter and absorb a second portion of the scattered light having a polarization state other than the first linear polarization;
wherein the interference filter is configured to reflect a reflected portion of the first portion of the scattered light back through the quarter wave retarder towards the linear polarizer, whereby the reflected portion of the first portion of the scattered light passes through the quarter wave retarder in a double pass, and the polarization state of the reflected portion of the first portion of the scattered light is converted from the first linear polarization to a second linear polarization substantially orthogonal to the first linear polarization; and
wherein the reflected portion of the first portion of the scattered light having the second linear polarization is substantially absorbed by the linear polarizer.

2. The optical eyewear filter of claim 1, further comprising an anti-reflective coating layer disposed between the interference filter and the linear polarizer.

3. The optical eyewear filter of claim 2, wherein the anti-reflective coating layer is disposed between the quarter wave retarder and the interference filter.

4. The optical eyewear filter of claim 2, wherein the anti-reflective coating layer is disposed between the quarter wave retarder and the linear polarizer.

5. The optical eyewear filter of claim 1, wherein the passband spectrum comprises primary colors.

6. Optical eyewear comprising first and second optical filters, wherein the first and second optical filters each comprise:
an interference filter having a passband spectrum;
a quarter wave retarder optically following the interference filter; and
a linear polarizer optically following the quarter wave retarder;
wherein the linear polarizer is configured to allow a first portion of scattered light having a first linear polarization to pass through the quarter wave retarder in a first pass towards the interference filter and absorb a second portion of the scattered light having a polarization state other than the first linear polarization;
wherein the interference filter is configured to reflect a reflected portion of the first portion of the scattered light back through the quarter wave retarder towards the linear polarizer, whereby the reflected portion of the first portion of the scattered light passes through the quarter wave retarder in a double pass, and the polarization state of the reflected portion of the first portion of the scattered light is converted from the first linear polarization to a second linear polarization substantially orthogonal to the first linear polarization; and
wherein the reflected portion of the first portion of the scattered light having the second linear polarization is substantially absorbed by the linear polarizer.

7. The optical eyewear of claim 6, wherein the interference filters of the first and second optical filters have the same passband spectrum.

8. The optical eyewear of claim 6, wherein the interference filters of the first and second optical filters have substantially non-overlapping passband spectrum.

9. The optical eyewear of claim 8, wherein the passband spectrum of the interference filters of the first and second optical filters comprise complementary colors.

10. The optical eyewear of claim 8, wherein the passband spectrum of the interference filters of the first and second optical filters comprise non-overlapping primary colors.

11. The optical eyewear of claim 10, wherein the passband spectrum of the interference filters of the first and second optical filters comprise R1G1B1 and R2G2B2, respectively.

12. The optical eyewear of claim 6, wherein the first and second optical filters each further comprise an anti-reflective coating layer disposed between the interference filter and the linear polarizer.

13. The optical eyewear of claim 12, wherein the anti-reflective coating layer is disposed between the quarter wave retarder and the interference filter.

14. The optical eyewear of claim 12, wherein the anti-reflective coating layer is disposed between the quarter wave retarder and the linear polarizer.

15. A spectral division optical system, comprising the optical eyewear of claim 6 and an image source configured to provide unpolarized image light within a field of view of the optical eyewear.

16. A spectral division optical system, comprising the optical eyewear of claim 6 and an image source configured to provide circular polarized image light within a field of view of the optical eyewear.

17. The spectral division optical system of claim 16, wherein the quarter wave retarders of the first and second optical filters of the optical eyewear are configured to have a slow axis orthogonally oriented with respect to a slow axis of the circular polarized image light.

18. A spectral division optical system, comprising the optical eyewear of claim 6 and an image source configured to provide linear polarized image light within a field of view of the optical eyewear.

19. The spectral division optical system of claim 18, further comprising an image source linear polarizer optically following the image source, and an image source quarter wave retarder optically following the image source linear polarizer.

20. The spectral division optical system of claim 19, wherein the quarter wave retarders of the first and second optical filters of the optical eyewear are configured to have a slow axis orthogonally oriented with respect to a slow axis of the image source quarter wave retarder of the image source.
